(19) United States
(12) Patent Application Publication
(10) Pub. No.: US 2002/0128977 A1
(43) Pub. Date: Sep. 12, 2002

(54) Microchip-enabled online transaction system

(76) Inventors: Anant Nambiar, New Rochelle, NY (US); Geoffrey Stern, Summit, NJ (US)

Correspondence Address: Thomas J. Finn, Snell & Wilmer L.L.P., One Arizona Center, 400 East Van Buren, Phoenix, AZ, 85004-2202, US

(21) Appl. No.: 09/952,490

(22) Filed: Sep. 12, 2001

Related U.S. Application Data
(60) Provisional application No. 60/232,040, filed on Sep. 12, 2000.

(51) Int. Cl. G06F 17/60

(52) U.S. Cl. 705/64

(57) ABSTRACT

A microchip-enabled online transaction system and method that emulates a “card-present” transaction in an online or remote environment by using an improved authentication and transaction system. More specifically, this system uses an authenticating instrument (e.g., smart card), an authenticating instrument reader (e.g., smart card reader), and a user-specific identification signature (e.g., user PIN) to better authenticate an online purchaser. Additionally, this system may also employ techniques (1) for transmitting to a merchant a secondary transaction number in place of the user's primary transaction account number, and (2) for automatically filling an online merchant's payment and shipping web pages with the appropriate profiled user information.

### CROSS REFERENCE TO RELATED APPLICATIONS

This application claims priority to, and the benefit of, U.S. provisional application Serial No. 60/232,040, filed on Sep. 12, 2000, which is hereby incorporated by reference.

### FIELD OF THE INVENTION

The present invention generally relates to a method and system for conducting a more secure and efficient computer-facilitated transaction. Specifically, this invention implements an improved user authentication process, which may include, for example, two factor authentication, to facilitate a more safe, secure and expedient computerized transaction.

### BACKGROUND OF THE INVENTION

The proliferation of the internet has resulted in a thriving electronic commerce industry, where more and more products and services are available to consumers in a variety of non-traditional ways (e.g., internet, telephone sales, wireless, interactive TV, etc.). In typical online consumer-merchant transactions, consumers typically provide merchants with transaction numbers (e.g., transaction card numbers) from their existing debit, phone, credit, charge, or other transaction instruments (e.g., American Express®, VISA®, MasterCard® and Discover Card®, AT&T®, MCI®, etc.). In conducting a standard online purchase, for example, a consumer often browses the internet for items to purchase. When the consumer finds an item that he or she is interested in purchasing, the consumer typically selects an item to add to a virtual shopping cart. When the consumer has finished shopping, and desires to purchase an item, the consumer usually proceeds to a virtual checkout, where the consumer is prompted for payment and delivery information. The consumer then typically enters the appropriate delivery and transaction card information in the appropriate purchase fields, wherein the consumer reads the transaction card number directly from the consumer's physical transaction card. This information is then transmitted electronically to the merchant via a distributed network such as the internet. Transmission of transaction numbers via these online systems has created increased opportunities for fraud because of the difficulty in authenticating the possessor of the card number to ensure that he or she is lawfully entitled to use this number and an increased opportunity for the card number to be intercepted either en route to the merchant or once at the merchant's site, by any unscrupulous merchant employee or third party. Although the transmission is often encrypted, there exists the possibility that the number will be intercepted en route to the merchant.

Unlike a typical “card-present” transaction where a consumer is present at a merchant's retail establishment and presents a physical transaction card to the merchant, the merchant in an online transaction does not physically see the consumer nor the transaction card. As such, in an online transaction, the merchant is not typically able to appropriately check the transaction number or the signature on the card, and does not have the sufficient capability to ask for other forms of identification. Therefore, since it has often been difficult to adequately authenticate a person in possession of a transaction card in an online transaction, it has been relatively easy for unauthorized users to complete online transactions. Thus, there exists a strong need within the transaction card industry for a method to authenticate remote and/or online users of transaction cards, where the merchant can be better assured that whoever is in possession of the card is authorized to use the card.

If sufficient authentication was practical, however, online fraud would still be possible because the number can be intercepted in transit to the merchant or stolen at the merchant's location. For example, it is possible for these numbers to be intercepted during transmission, after transmission, or while being stored electronically at the merchant's online or offline location. Therefore, there also exists a need to provide greater security in online transactions even where the cardholder may be suitably authenticated. In order to limit exposure to online fraud, various systems and methods have explored the use of limited-use or temporary transaction numbers instead of the cardholder's primary transaction card number. For example, see related application “A System For Facilitating Transactions,” Ser. No. 09/800,461, filed on Mar. 7, 2001, and owned by American Express, Inc., which details the use of secondary transaction numbers in place of primary transaction account numbers.

Online fraud is not the only deterrent for consumers contemplating an online transaction. The online transaction process can be laborious and time-consuming. Typically, when desiring to conduct an online transaction, the consumer completes several fields prior to finalizing a purchase. For example, the consumer manually inputs his or her name, address, delivery address, the expiration date, card number, etc. Each and every time the consumer desires the make a purchase, he or she often re-enters this information. As such, a need also exists for a system that minimizes cardholder re-entry of information.

### SUMMARY OF THE INVENTION

The present invention integrates an authentication instrument (e.g., smart card, PDA, transponder, etc.), an authentication instrument reader (smart card reader, transponder reader, etc.), and a user-specific identification signature (password, PIN, fingerprint ID, etc.) with a host system transaction service to facilitate an improved and more secure computer-facilitated (e.g., online) transaction process between the holder (e.g., the “user” or “cardholder”) of the authentication instrument and a merchant.

In an exemplary online embodiment utilizing an exemplary two-factor authentication process, a user, while shopping at a merchant website clicks on a secure payments button. This button redirects the user's browser to a host system. The host system sends the user a challenge string (e.g., date encoded string), prompts the user to insert his or her smart card into the smart card reader attached to the user's computer system and enter a PIN. Upon entering the PIN, access to a private key and digital certificate residing on the smart card is granted. The challenge string is then signed. This signed challenge string and the digital certificate is communicated to the host system. The digital certificate is validated by the host system to establish that the smart card is an authorized transaction/authentication card, and that it is present in the reader (first factor). The user is authenticated by providing his or her PIN, which causes the host-specified challenge string to be signed (second factor) and transmitted to the host system. Once the user is authenticated, in an exemplary embodiment, the host system retrieves the user's primary transaction account (i.e., payment) information (e.g., charge card number) and communicates this account information to the merchant to facilitate the transaction.

The exchange of transaction data between the authenticated user and the merchant, which may be necessary to complete the transaction process, can be facilitated by a number of methods. The present invention may utilize, for example, user-profiling techniques to expedite the online transaction process. For example, user profile information (e.g., name, address, shipping and billing information, etc.) may be stored and retrieved from a digital wallet (i.e., user profile database) maintained on the host system site, the merchant system, the user's system and/or on the authentication instrument. User-profiled information may be retrieved from any one of these digital wallet embodiments to automate the online transaction process for the user.

In accordance with one embodiment of this invention, user profiled data (e.g., full name, address, etc.) may be retrieved from a host system digital wallet associated with the user. Upon user-authentication, this digital wallet information, along with the payment or account information (e.g., charge card number), is then used to automatically complete the merchant transaction fields for the user—thereby completing the transaction process.

In accordance with additional exemplary embodiments of this invention, the user may choose to (1) manually complete the merchant transaction fields, (2) use profiled transaction data stored on a payment or authentication device (e.g., smart card) to complete the merchant transaction fields, or (3) have a merchant-provided or third-party-provided online wallet complete the relevant transaction fields. Utilizing these methods, the host system, upon selection of the secure payment button by the user, authenticates the user for the merchant. To authenticate the user to the merchant, the transaction information entered by the user is matched with user authentication information provided by the host system. In an exemplary embodiment, the particular user transaction is coded (e.g., session cookie, transaction code, etc.) so the merchant is able to match the user transaction data provided by the user, smart card or other third parties, with the user authentication data provided by the host system. Therefore, in this exemplary embodiment, to authenticate the user, the digital certificate and signed challenge string are passed to the host system with a transaction identifier (e.g., session cookie or transaction code), the host system authenticates the user, and returns a “user-authenticated” message to the merchant along with the transaction identifier. The merchant then matches the transaction identifier returned from the host system with the transaction identifier associated with a particular user to verify that the profiled user information is associated with an authenticated user.

To provide added security and to lessen the risks and potential liabilities associated with online or remote transactions, the present invention may also be configured in an exemplary embodiment to utilize limited-use or temporary transaction account numbers that are associated with the user's primary transaction account, so that the user's primary transaction account number need not be transmitted over the internet.

This invention contemplates not only online communication via the internet, but also communication of authenticating data over any communication network, such as telephone systems.

### BRIEF DESCRIPTION OF THE DRAWINGS

Additional aspects of the present invention will become evident upon reviewing the non-limiting embodiments described in the specification and the claims taken in conjunction with the accompanying figures wherein like reference numerals denote like elements.

FIG. 1 is an overview of exemplary components of the present invention;

FIG. 2 is an exemplary schematic overview of the smart card-enabled online transaction process of the present invention;

FIG. 3 is an exemplary schematic depicting the process flow involved with the host systems; and,

FIGS. 4-8 are exemplary web page screen shots of the present invention of a card provider's exemplary online registration page for a transaction system.

### DETAILED DESCRIPTION OF EXEMPLARY EMBODIMENTS

The present invention provides a system and method for conducting any transaction with the increased security, confidence and speed of a card-present transaction. As previously noted, a typical card-present transaction is a transaction where the consumer shops for goods and services at a physical merchant establishment and, upon selecting a product to purchase, presents a physical transaction card (e.g., charge, credit or other stored value card) to the store clerk for processing. In this situation, the store clerk typically swipes the card through a point-of-sale (POS) terminal, whereupon the card data is generally transmitted through a banking network to a card authorization system for approval. With the card actually presented to the merchant, the merchant has the opportunity to request identification or obtain a signature in order to authenticate the user (i.e., to ensure that the identity of the person using the card is the same as the name and/or photo appearing on the face of the card).

Exemplary embodiments of the microchip-enabled online transaction system of the present invention offer, inter alia: (1) improved authentication by utilizing a digital certificate encoded on a microchip-enabled authentication instrument (e.g., smart card, PDA, transponder, etc.), an authentication instrument reader (e.g., smart card reader, etc.) for reading the digital certificate, and a user identification signature (e.g., password, personal identification number (PIN), biometrics signature, etc.) to authenticate the user; (2) improved security by transmitting a transaction-specific or limited use secondary transaction number in place of the user's primary transaction account number to limit exposure should the transaction number be intercepted or stolen; and/or (3) improved performance by using a user-specific profile to automatically complete the merchant's payment and delivery fields in order to more efficiently and expeditiously facilitate the online transaction process.

This system and method generally employs existing card authorization, settlement and processing systems currently used by financial institutions such as American Express, Visa, MasterCard, etc. Therefore, other than the user authentication hardware and software (e.g., smart card reader and software on the user's system) and software on the merchant system to recognize the presence of reader software on the user's system, there is little need for special customization. As such, the present invention is an improved system for facilitating transactions that is easily and readily adaptable to existing commercial transaction processing systems.

A. Overview of Exemplary Components of the Present Invention

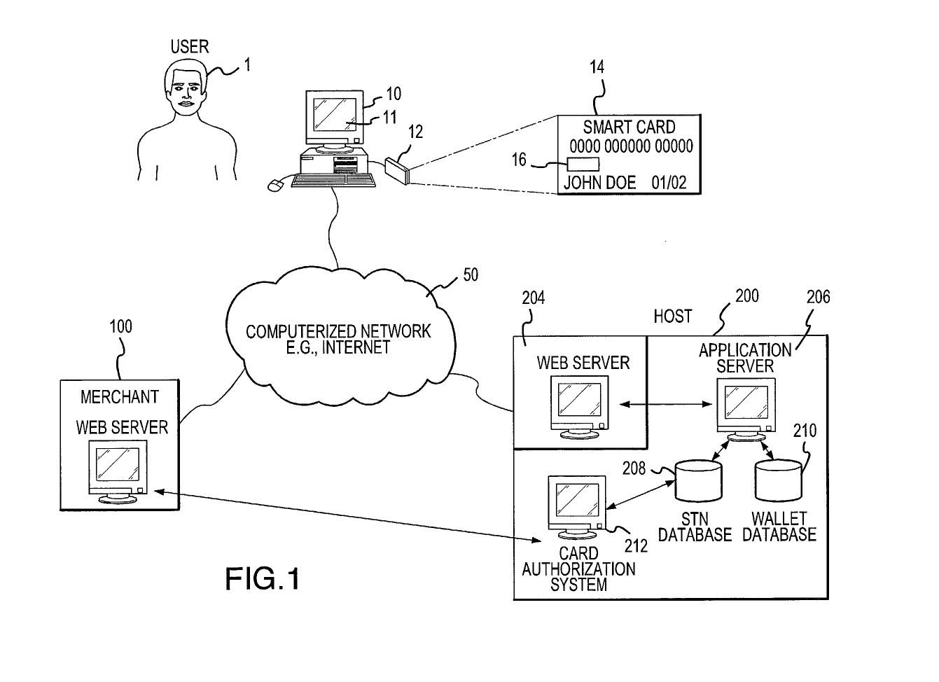

FIG. 1 depicts the exemplary components of an embodiment of the present invention. The microchip-enabled online transaction system enables interaction between a user 1, a merchant 100 and a host system 200 via a computerized network 50 to facilitate a transaction. As such, this invention may be facilitated in any number of ways; for example, online over the internet, a direct connection with a host system 200, a direct wire (telephone), wireless/cellular connection (e.g., WAP), and/or the like. Although an exemplary embodiment of this invention is described herein, in part, in terms of communication over the internet, it should be appreciated that communication via a variety of other means, such as the telephone, is also contemplated.

The user 1, as defined herein, includes any hardware, software, entity, person, system or business that utilizes an interconnected and/or distributed network system to facilitate a transaction. The user 1 includes any transaction cardholder, consumer, customer, purchaser, and/or the like. The user 1 facilitates communication with the merchant 100 and host system 200 via a user system 10, which is suitably configured for communicating and/or connecting to a computerized network 50. An authentication device (e.g., smart card reader 12) communicates with, and software is loaded on, the user system 10 to ensure proper communication and transmission of data from the user system 10 to the host system 200 and/or the merchant 100.

Referencing FIG. 1, an exemplary embodiment of the present invention contemplates a user 1 location that is remote from the physical merchant 100 site and the host 200 site. In an alternative embodiment, the user system 10 may be located in a kiosk or other suitable terminal at the merchant 100 or other third-party location. The user system 10 comprises any hardware and/or software suitably configured to access a computerized network 50 such as the internet. The user system 10 may include hardware components such as a keyboard, mouse, monitor, disc drives, processing systems, memory modules, etc. Software systems that may be desired and/or necessary include operating systems to establish communication channels between the user 1, the merchant 100 and/or the host system 200, such as Microsoft Windows® 2000 and internet web browsing programs such as Microsoft Internet Explorer® or Netscape Navigator( browsing applications. In an exemplary embodiment, the user system 10 is configured with a web browser 1, which facilitates a communication channel with merchant 100 and/or host system 200, for accessing, viewing and searching the internet. The user system 10 is also configured with an authentication instrument reader, such as a smart card reader 12, which, as described later, may be any device capable of reading the authentication instrument (e.g., smart card 14). In an exemplary embodiment, the smart card reader 12 is configured with software to read data from the user's smart card 14. An example of a smart card 14 is the Blue™ transaction card offered by American Express®), which may be used as a standard American Express credit card and has affixed thereto a microchip 16 commonly referred to as a smartchip.

Authentication instruments and authentication instrument readers are broadly defined to include all types of devices capable of storing, generating, and/or transmitting digital certificates, authentication codes, and/or the like in order for the host system 200 and/or merchant 100 to better authenticate the user 1 and to more securely carryout a transaction. As such, even though a smart card reader 12 and smart card 14 are referenced throughout this specification, these terms should not limit the scope of this invention. While one embodiment of the present invention contemplates the use of a microchip 16 enabled smart card 14 and smart card reader 12 authentication system, the authentication system described herein, should be broadly understood to include other variations of authenticating means, including, for example, magnetic stripe cards/readers, RFID transponders, contactless transponders, biometrics devices (e.g., retinal, voice/sound, fingerprint recognition), ultrasound or infrared-capable devices, bar codes, numeric sequences, and/or the like. Although any smart card operating system should be considered within the scope of this invention, exemplary embodiments may utilize Multi-Application Operating System (MULTOST™), Java™ or other proprietary smart card/smart chip operating systems and functionalities, and includes both contact and contactless (or combination) cards. The smart card 14 may be issued to the user 1 by the host system 200. Alternatively, the smart card 14 may be issued in some circumstances by the merchant 100.

In an exemplary embodiment, two factor authentication is implemented using (1) a digital certificate stored on the microchip 16, and (2) a signed challenge string obtained by providing an appropriate user-specific identification signature. The smart card 14 may also contain algorithms, keys, certificates, applets, etc., in addition to or in lieu of the digital certificate, as necessary, to display and encrypt/decrypt authenticating information. Although the term “digital certificate” is a cryptographic term generally recognized in the computing industry, the term “digital certificate,” as defined herein should be interpreted broadly to include any user or card identifying code, key, algorithm and/or other authenticating indicia. The smart chip 16 may include an applet which contains a private key that identifies the user 1. A signed challenge string and the digital certificate are transmitted via the internet 50 to the host system 200, either directly from the user 1 or via the merchant 100 and/or another third-party system. As described later, the signed challenge string and digital certificate provide two-factor authentication and establish the “card present” transaction. For more information related to smart cards, transaction cards and related readers, see U.S. Pat. Nos. 5,905,908, 5,742,845, and 5,898,838, owned by Datascape, Inc., the general functionality of which is hereby incorporated by reference. Also see U.S. patent application Ser. No. 09/734,098, filed Dec. 11, 2000, and owned by American Express TRS, which is hereby incorporated by reference.

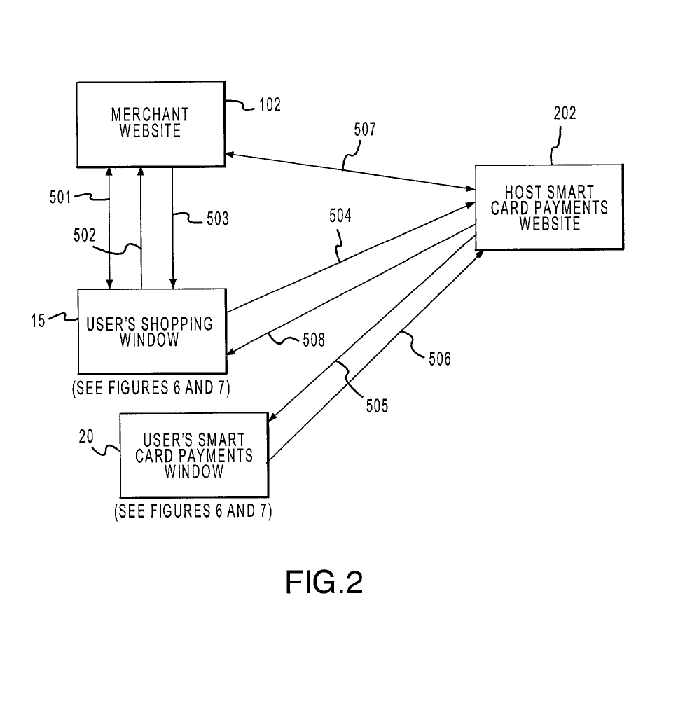

The merchant 100, as defined herein, is any hardware or software system, entity, person and/or business that provides goods or services to users via an interconnected and/or distributed network such as the internet. The merchant 100 system includes hardware and software components such as web servers, application servers and databases to facilitate the online shopping presence (i.e., a shopping website). An exemplary merchant shopping website 102 (FIG. 2) is a virtual shopping page accessible to the user 1 via the user's web browser 11 (see, e.g., user's shopping window 15). In an exemplary embodiment, the host system 200 provides the merchant 100 with program code (e.g., client side script, such as JavaScript or VBScript, embedded within the web page HTML) that looks for the presence of host system software files (e.g., smart card reader software) on the user system 10. In an exemplary embodiment, the host system 200 provides another program code that, upon recognizing the presence of a smart card reader 12 on the user system 10, generates a secure payment or “smart card payment” button that is displayed to the user 1 on the user's browser. Thus, the secure payment button appears on the user's browser for those user systems 10 suitably configured with an appropriate authentication reader device. In accordance with a telephonic-facilitated embodiment of this invention, the merchant 100 system may be configured with a telephone ordering system capable of receiving authenticating data and voice data over a telephone network system, where a merchant 100 switching system or router to retrieves authenticating data from a user 1 over an appropriate distributed network (broadly defined herein to include a telephone network) using a suitably configured user system 10 (e.g., smart card enabled telephone) and redirect the authenticating data to a host system for authentication. When referring to the redirection of a web browser throughout this application, it should be understood that this contemplates redirecting any authenticating information from the user 1 to the host system 200 for authentication.

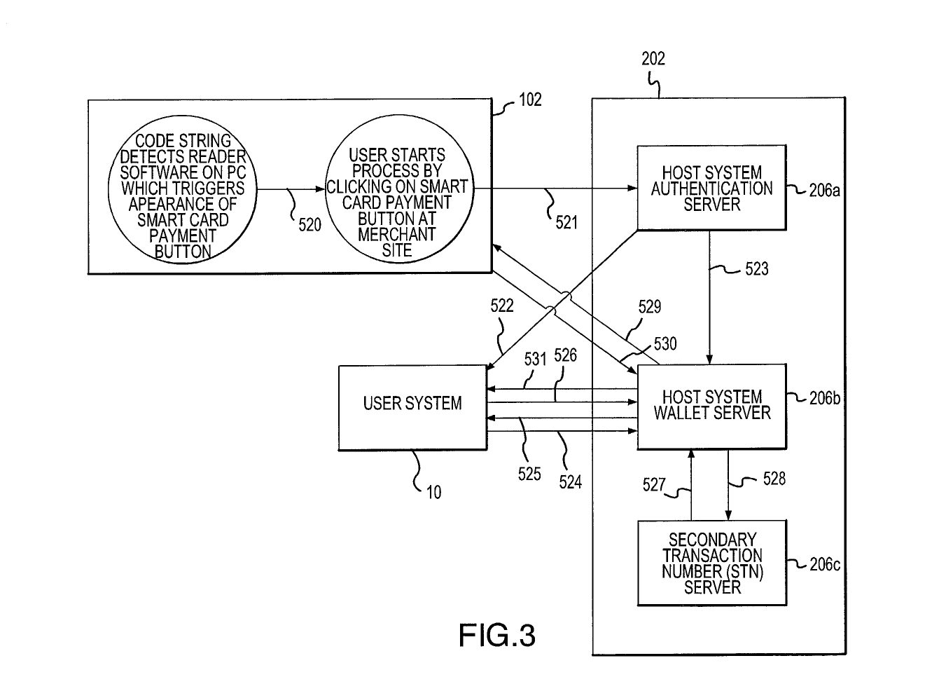

A wallet server 206b (FIG. 3), which may be hosted by the host system 200, the merchant system, or other third-party systems may also be utilized to manage a database of user digital wallets. Alternatively, user-profiled information (e.g., name, address, shipping and billing information) may be stored on the user's smart card 14 or on the user system 10. As explained later, user-profiled information maintained, for example, in a digital wallet typically makes buying items on the web faster and more convenient. The profiled information may contain personal user 1 ordering information, charge account numbers, shipping addresses and/or the like. The profiled information also expedites the online ordering process by automatically completing merchant online order forms for the user 1. In an exemplary embodiment, a user's digital wallet that is maintained by the host system 200 is opened or unlocked when the user 1 inserts his or her smart card 14 into a smart card reader 12 and enters the PIN. In accordance with an exemplary embodiment employing a temporary or secondary transaction number, after the user is authenticated by the host system authentication server 206a, the wallet server 206b interfaces with a secondary transactions (STN) server 206c (FIG. 3) to generate a temporary or limited use number that substitutes for the user's actual charge account number. Although an exemplary embodiment of the online wallet, as shown in FIG. 3, contemplates a host system wallet server 206b, with a software plug-in stored within the user system 10 or smart card 14, this invention, utilizing an appropriate transaction code or session ID (e.g., cookie or transaction code) to match up user transaction data (e.g., address, name, etc.) with the host system authentication data, also contemplates manual completion of the merchant transaction fields or a digital wallet that is stored on the user system 10 (e.g., the user's personal computer), the user's smart card 14, the merchant 100 system or any third-party digital wallet system. For more information on online wallet systems, see U.S. application Ser. No. 09/652,899, “Methods And Apparatus For Conducting Electronic Transactions,” filed Aug. 31, 2000, which is hereby incorporated by reference.

As noted above, an exemplary embodiment of the present invention includes the generation of a temporary or limited use transaction number called a secondary transaction number (STN). The STN is generated by the host system 200 and is associated with the user's primary transaction account number (e.g., the number embossed on the face of the smart card). The STN may be any transaction number, code, symbol, indicia, etc., that is associated with any other number or account that has been designated by the user 1 or the host system 200 as a primary account number. For more information on secondary transaction numbers, see, for example, “A System For Facilitating Transactions” disclosed in Ser. No. 09/800,461, filed on Mar. 7, 2001, and owned by American Express, Inc. For additional background information on loyalty, stored value, electronic commerce and digital wallet systems, see U.S. Ser. No. 09/834,478, filed on Apr. 13, 2001; the Shop AMEX™ system disclosed in U.S. Ser. No. 60/230,190, filed Sept. 5, 2000; a digital wallet system disclosed in U.S. Ser. No. 09/652,889, filed Aug. 31, 2000; and a stored value system disclosed in U.S. Ser. No. 09/241,188, filed on Feb. 1, 1999; all of which are herein incorporated by reference.

Exemplary components of the host system 200 include any hardware and/or software elements capable of facilitating the smart card enabled transaction between the user 1 and the merchant 100. The host system 200 may or may not include open loop financial banking systems such as that utilized by the Visa or MasterCard networks or closed loop systems such as that used by American Express. The host system 200 also contemplates telephone or utility companies or other account management institutions. The host system 200 includes any transaction (charge, credit, loyalty, etc.) card provider or issuer, charge or transaction card company, or other third-party host system capable of facilitating the processes of the present invention. Exemplary systems employed by the host system 200 may include components for presenting an online presence such as the host website (e.g., web server 204), for processing user and transaction data (e.g., application server 206), data storage means for storing user, transaction and/or merchant data (e.g., STN database 208, wallet database 210, etc.), a card authorization system 212 and settlement systems (not shown).

When referring to exemplary components of the present invention, it should be noted that the present invention may be described herein in terms of functional block components, flow charts, screen shots, optional selections and various processing steps. It should be appreciated that such functional blocks may be realized by any number of hardware and/or software components configured to perform the specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the present invention may employ any number of conventional techniques for data transmission, encryption, decryption, signaling, data processing, network control, and the like.

It should be appreciated that the particular implementations shown and described herein are illustrative of the invention and its best mode and are not intended to otherwise limit the scope of the present invention in any way. Indeed, for the sake of brevity, basic smart card technology, digital wallet, conventional data networking, application development and other functional aspects of the systems (and components of the individual operating components of the systems) that are commonly known to those skilled in this area of technology and do not effect the enablement of this invention may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It will be appreciated, that many applications of the present invention could be formulated. One skilled in the art will appreciate that a network may include any system for exchanging data or transacting business, such as the internet, an intranet, an extranet, WAN, LAN, satellite or wireless communications, and/or the like. The user 1 may interact with the host system or a merchant's online website via any suitable input device such as a keyboard, mouse, kiosk, personal digital assistant, touch screen, transponder, handheld computer (e.g., Palm Pilot®), cellular phone, web TV, web phone, smart card enabled web tablet, blue tooth/beaming device and/or the like. Similarly, the invention could be used in conjunction with any type of personal computer, network computer, workstation, minicomputer, mainframe, or the like running any operating system such as any version of Windows, MacOS, OS/2, BeOS, Linux, UNIX, or the like. Moreover, although the invention uses protocols such as TCP/IP to facilitate network communications, it will be readily understood that the invention could also be implemented using IPX, Appletalk, IP-6, NetBIOS, OSI or any number of existing or future protocols. Moreover, the system contemplates the use, sale, exchange, transfer, or any other distribution of any goods, services or information over any network having similar functionalities described herein.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, flash card memory and/or the like.

Communication between the parties (e.g., user 1, host system 200, and/or merchant 100) to the transaction and the system of the present invention may be accomplished through any suitable communication means, such as, for example, a telephone network, intranet, internet, extranet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The present invention is described herein with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus (e.g., smart card) to cause a series of operational steps to be performed on the computer or other programmable apparatus to produce a computer-implemented process such that the instructions which execute on the computer or other programmable apparatus provide steps for implementing the functions specified in the flowchart block or blocks.

Referencing the computer networked aspect of a preferred embodiment of this invention, each participant is equipped with a computing system to facilitate online commerce transactions. The computing units may be connected with each other via a data communication network. In the illustrated implementation, the network is embodied as the internet 50. In this context, the computers may or may not be connected to the internet at all times. For instance, the user 1 computer may employ a modem to occasionally connect to the internet 50, whereas the host system 200 might maintain a permanent connection to the internet 50. It is noted that the network may be implemented as other types of networks, such as an interactive television (ITV) network, a wireless network, etc.

The merchant 100 computer systems and the host system 200 also be interconnected via a second network, referred to as a payment network. The payment network represents existing proprietary networks that presently accommodate transactions for transaction cards, debit cards, and other types of financial/banking cards. The payment network is a closed network that is assumed to be secure from eavesdroppers. Examples of the payment network include the American Express®, VisaNet® and the Verifone® network.

B. The Processes of the Present Invention

Functional blocks of the block diagrams and schematic illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. As previously noted, in the present invention, communication between the parties to the transaction may take place over any type of distributed network. The term “distributed network” should be broadly interpreted to mean any network or means for communicating analog or digital data, such as the internet, intranet, LAN, wired (telephone), wireless, and/or the like. Accordingly, although an online embodiment is illustrated throughout, another exemplary embodiment, for example uses a telephone network for communicating information to the host 200 or merchant 100 systems. During a telephone ordering process, for example, the user 1 communicates authenticating information over a wired or wireless network by communicating the microchip-enabled device with the telephone directly or a microchip reader attached to (or in communication with) the telephone. Authenticating data is transmitted over the telephone network to the merchant and redirected or routed to the host system 200 for authentication. This communication of authenticating information from the microchip-enabled device, such as a smart card, to the host system 200 facilitates the authentication process herein described.

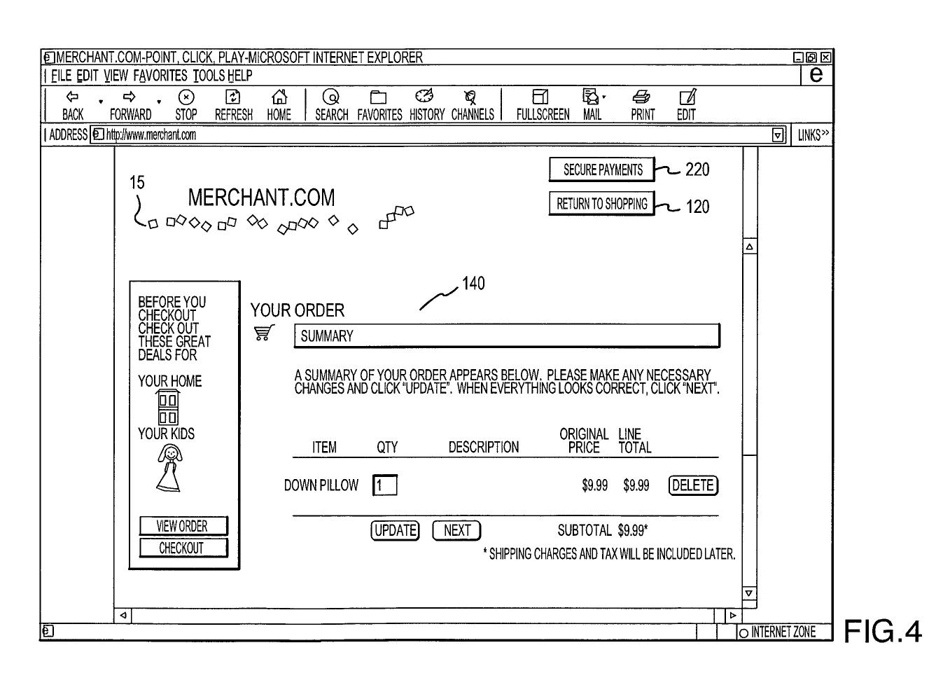

In an exemplary online embodiment, as illustrated in FIGS. 1 and 2, a communication channel is established between the user 1 and the merchant 100 with a web browser 11. A user 1 desiring to purchase a product from an online merchant's website 102, directs his or her web browser 11 to a merchant's website 102. The user browser 11 window at the merchant's online shopping page, referred to as the user's shopping window 15, is illustrated in FIG. 2. To make a purchase, the user 1 places a product in an online shopping cart by any suitable method, such as, for example, clicking on the appropriate product buttons or icons. At some point in time during the transaction processing, and depending on the particular merchant 100 involved, the merchant's web server system is able to detect the host system smart card reader software on user system 10. With the user system 10 properly configured with an authentication instrument reader such as a smart card reader 12, the user 1 is capable of facilitating the authentication processes described herein. Recognizing that the user system 10 is configured with a authentication instrument reader and software, the merchant's website 102 presents to the user 1, via the user's shopping window 15, a “secure payment” button 220 (FIG. 4) (STEP 501 in FIG. 2). As previously noted, the merchant's computer systems are configured with program codes that recognize the host system authentication instrument reader software that is present on the user system 10. The merchant system is also configured with a code to present a “secure payment” button 220 on the user's shopping window 15 upon detection of the authentication instrument reader. If a user system 10 is not suitably equipped with the appropriate authentication device, the secure payment button 220 will not appear.

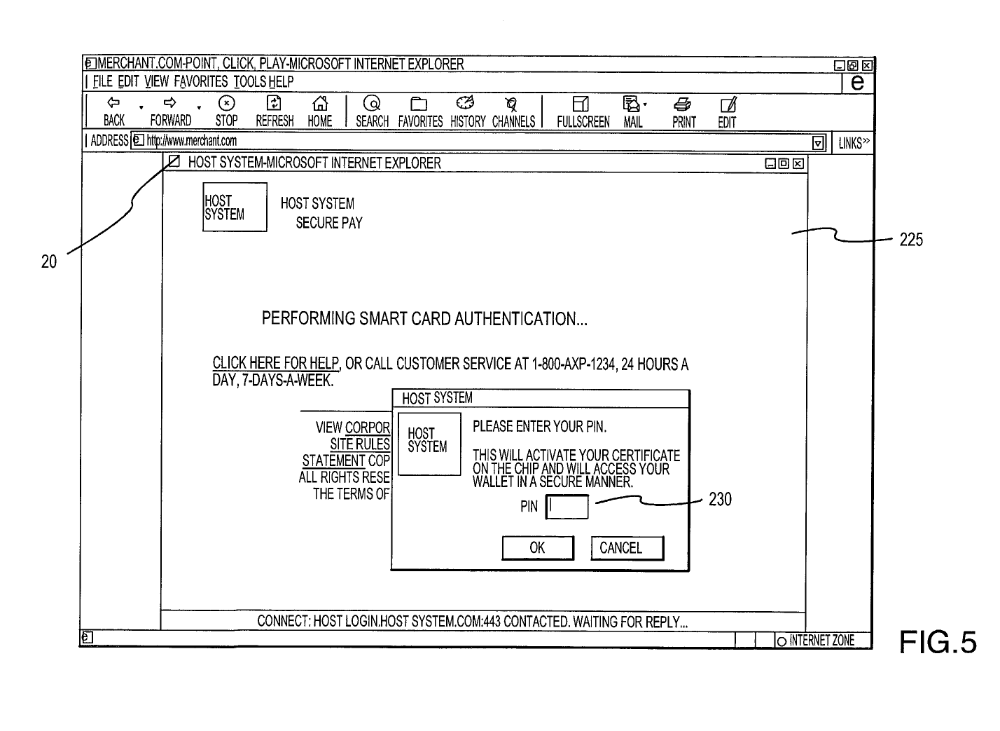

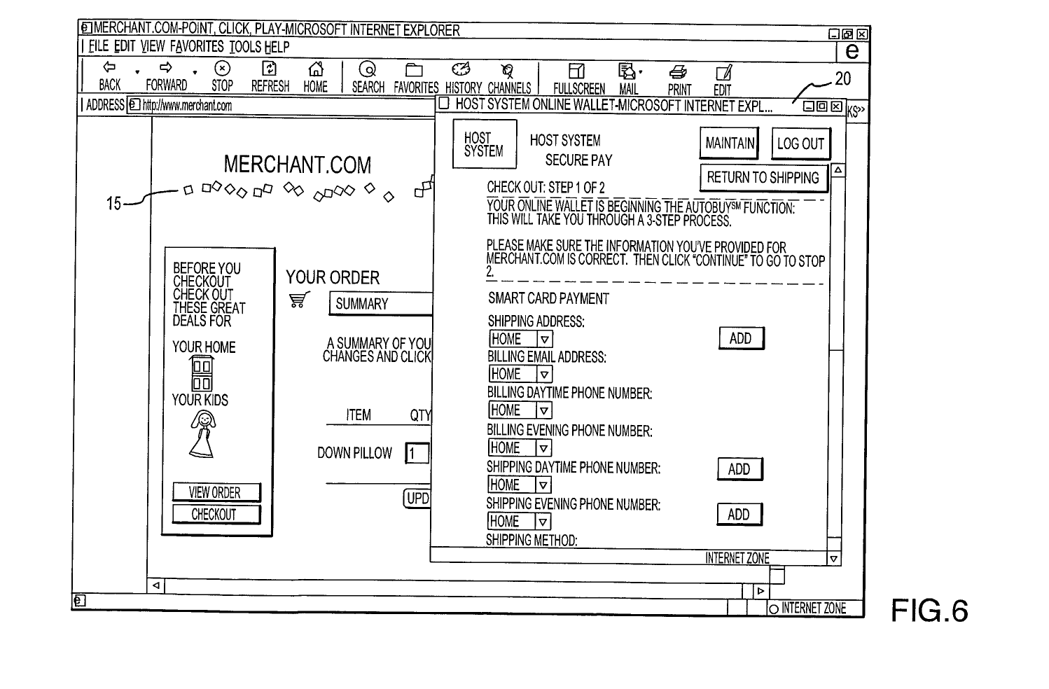

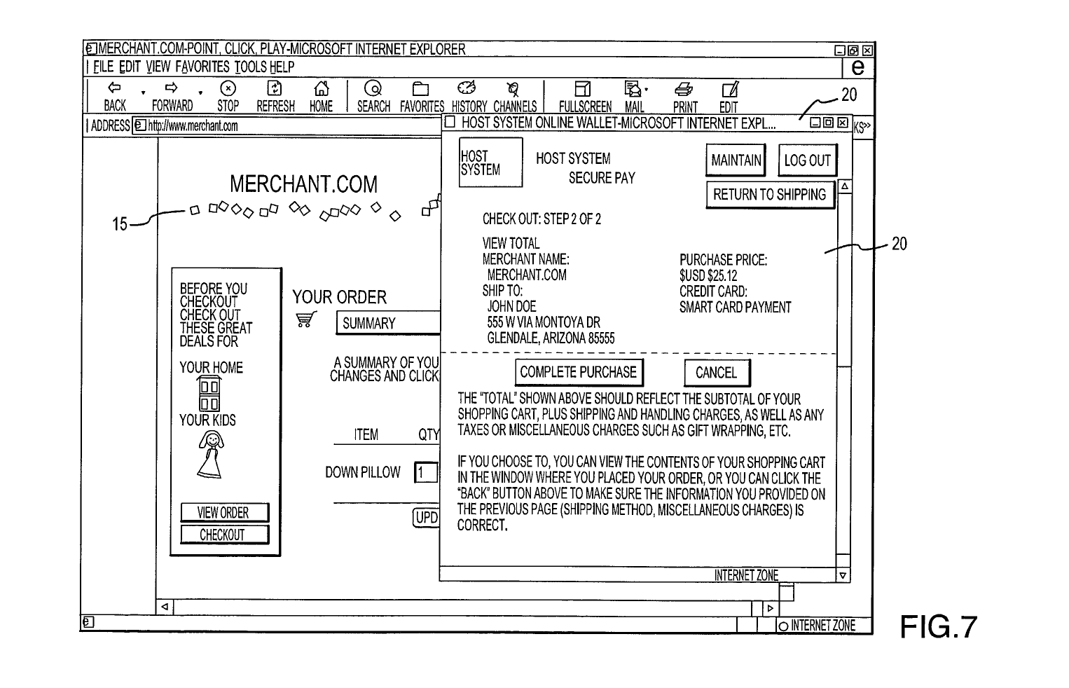

An exemplary merchant web page screenshot of the user's shopping window 15 at the order summary 140 is depicted at FIG. 4, and shows an order summary page 140, the smart card payments button 220, and a link returning the user 1 to shopping 120. In the exemplary screenshot of FIG. 4, the user 1 has selected a down pillow for $9.99. By clicking the smart card payments button 220 (STEP 502 in FIG. 2), the user 1 invokes the microchip-enabled online payment process using the user's smart card 14. The merchant website 102 then calls a host system-defined JavaScript (or other suitable scripting routine) (STEP 503). The JavaScript routine redirects the user communication channel (e.g., web browser) from the merchant 100 to the host system 200, i.e., the user's browser 11 is redirected from the merchant's website 102 to the host system website 202 (Step 504). The host system opens up a second browser window for the user 1 (smart card payments window 20) and the original browser window (user's shopping window 15) is redirected back to the merchant website 102 (STEP 505). FIGS. 5 and 6 are screen shots depicting the shopping window 15 and smart card payments window 20. The host system 200, recognizing that the browser from user system 10 has been redirected for a secure payment transaction, prompts the user 1 to insert his or her smart card 14 and to enter the appropriate PIN. The user 1 inserts the smart card 14 into the smart card reader 12 and enters a PIN. A signed challenge string and a digital certificate is then returned to the host system 202 for authentication (STEP 506).

An exemplary authentication process of the present invention provides for two-factor authentication. The essence of the two-factor authentication is combining something you have (i.e., an authentication instrument) with something known (i.e., a user-specific identification signature). The first factor includes the transmission of a digital certificate stored on the smart card 14 from the user system 10 to the host system 200. In an exemplary embodiment, each smart card 14 possesses a digital certificate that is unique to that particular smart card 14. With this certificate, the host system 200 compares the certificate to information maintained in a host system 200 user or account database to determine if the smart card 14 is an authorized transaction card. The release of this digital certificate to the host system 200, may be tied, in an exemplary embodiment, to the user's entry of his or her password or PIN number, where the combination of the digital certificate and the password is unique to the particular user 1. In an exemplary embodiment, the host system 200 prompts the user 1 to enter a password. When the user 1 enters his or her password, the host system 200 authenticates user 1 and determines whether user 1 is authorized to use the smart card 14 in his or her possession. Therefore, with this two-factor authentication, the host system 200 is able to determine with a reasonable degree of certainty that the smart card 14 is an authorized transaction card and that the person using this card is authorized to do so. Thus, the digital certificate and the challenge and password routine, authenticates the user 1 to the host system 200. The host system 200 is then able to deliver transaction approval and identification information to the merchant 100 reflecting that the user (and the associated transaction information) has been properly authenticated.

In an exemplary embodiment, entry of the password or PIN releases the digital certificate to the host system 200, authenticates the user 1, and allows the user 1 to access a digital wallet maintained, for example on the host system wallet server. The digital wallet may take many forms. For example, a digital wallet may be as simple as maintaining basic user account and address data in a database. In more enhanced embodiments, the digital wallet may retain user profile data, shopping preferences, merchant preferences, loyalty data, account data, shipping and delivery information, etc. The digital wallet may include various application servers and databases to achieve the desired wallet functionality. For example, as illustrated in FIG. 3, in an exemplary embodiment of the present invention the digital wallet server 206b is configured to communicate with a STN server 206c to generate a secondary transaction number. The digital wallet server 206b may also keep merchant profile data indicating transaction field codes and criteria required to complete transactions with particular merchants. In an exemplary embodiment, the merchant 100 data may be stored in a separate merchant profile database. In another embodiment, the host system 200 does not need to rely on the merchant 100 to provide the transaction field data; the host system 100 may either guess the transaction fields by evaluating applicable HTML codes, or gather merchant transaction fields by scraping or crawling merchant website data for this information.

FIG. 6 depicts an exemplary first step of an exemplary check out screen after authentication using an online digital wallet feature. At the checkout screen, the user 1 is able to select from a number of predefined digital wallet fields such as billing address, shipping address, shipping method, etc. If the user 1 has not previously entered digital wallet data, the user 1 is then prompted to add user data, at which point the data would be stored in the user's digital wallet for later retrieval. If the online merchant's payment and delivery fields have already been identified by the host system 200, the online wallet automatically completes certain fields, such as, for example, fields indicated by the merchant 100 as “required.” In FIG. 6, the user 1 may then select to proceed. The second step of the transaction process at the host system 200 entails the user 1 confirmation of the amount, shipping address, billing address, merchant name, etc. To complete the purchase the user 1 selects the complete purchase button (not shown).

It should be appreciated that the authentication system and methods of the present invention may be utilized not only with a host system user wallet, but with user profiled information maintained on the user system 10, on the user's authentication instrument (e.g., smart card 14), or in a wallet maintained by the merchant 200 or another third-party system. As described above, in accordance with one embodiment of this invention, the host system 200 may authenticate the user 1 and complete the transaction for the user 1 by providing all or part of the transaction information requested by the merchant 100 from the host system wallet. In accordance with another embodiment of this invention, the transaction information may be provided by an entity other than the host system, such as the user 1, the merchant or third-party wallet systems. As such, the host system 200 may be called upon by the merchant 100 to either (1) authenticate a user 1 who has provided all necessary transaction information (e.g., payment and delivery information) to the merchant, or (2) to both authenticate the user 1 and provide payment information in the form of the user's account number or a temporary transaction number (STN). For example, to authenticate the user 1, the merchant 100 may prompt the user 1 insert the user's smart card 14 into a smart card reader 12. When the user 1 inserts the smart card 14 into the smart card reader 12, authenticating data (e.g., a digital certificate and a signed challenge string) is passed to the merchant 100. The merchant receives this authentication information from the user 1. The authentication information is tagged with a transaction identifier (e.g., session cookie, transaction code, etc.) so that the merchant 100 is able to associate the transaction information provided by the user 1 (or other third party) with the authentication information. To facilitate this authentication process, the merchant 100 redirects or re-routes this tagged authentication information (e.g., digital certificate and signed challenge string) to a host system 200 for authentication. The host system 200 receives the authentication data and authenticates the user 1 as previously described. The host system 200 returns the tagged authentication message to the merchant indicating whether or not the smart card 14 is valid and the user authorized to use the smart card 14. In an exemplary embodiment, the user 1 may provide the payment information to the merchant, where the host system 200 merely authenticates that the user 1 was authorized to use the smart card 14 for payment. In another exemplary embodiment, however, the user 1 does not provide the payment information to the merchant 100, but rather, as part of the authentication process, the host system 200 provides as payment to the merchant 100, the user's account number or, alternatively, a temporary transaction number associated with the users' account number (described below).

In an exemplary embodiment, after authentication, the host system 200 generates a secondary transaction number (STN) for the particular amount of the transaction. In an exemplary embodiment, the digital wallet server 206b accesses a STN server 206c, which generates a secondary transaction number and associates that number with the user's 1 primary transaction account number. The digital wallet retrieves this STN, which may be a single or limited use transaction number. In other embodiments, other host system servers may access the STN server 206c. The STN may be limited for use with a particular merchant, limited to a particular expiration date and/or may be tailored to other transaction-specific, merchant-specific, or user-specific criteria. In an exemplary embodiment, the STN and the user's primary account have the same industry-standard format, although additional embodiments may provide for account numbers with varying formats. In an exemplary embodiment involving credit, debit, or the banking cards, the STN has the same industry standard format that is used for regular banking cards (e.g., 15 or 16 digit numbers). The numbers may be formatted such that one is unable to tell the difference between a STN and a regular physical credit or transaction card. Alternatively, however, the host system 200 identifier (e.g., BIN range, first 6 digits, etc.) numbers may be different so as to differentiate the STNs from regular transaction card numbers. In referencing the STN and the user's 1 primary account number, it should be appreciated that the number may be, for example, a sixteen-digit transaction card number, although each host system 200 has its own numbering system, such as the fifteen-digit numbering system used by American Express®. The host system 200 account numbering generally complies with a standardized format such that a host system 200 using a sixteen-digit format will generally use four spaced sets of numbers, as represented by the number “0000 0000 0000 0000.” The first five to seven digits are reserved for processing purposes and identify the issuing bank, card type, etc. In this example, the last sixteenth digit is used as a check sum for the sixteen-digit number. The intermediary eight-to-ten digits are used to identify the user 1. The present invention contemplates the use of other numbers, indicia, codes, or other security steps in addition to the use of the STN, but in an exemplary embodiment, the STN is provided to the merchant 100 to facilitate the payment for a transaction. In other words, an exemplary embodiment of the present invention, inter alia, eliminates the need to transmit the user's 1 actual transaction card number over the internet.

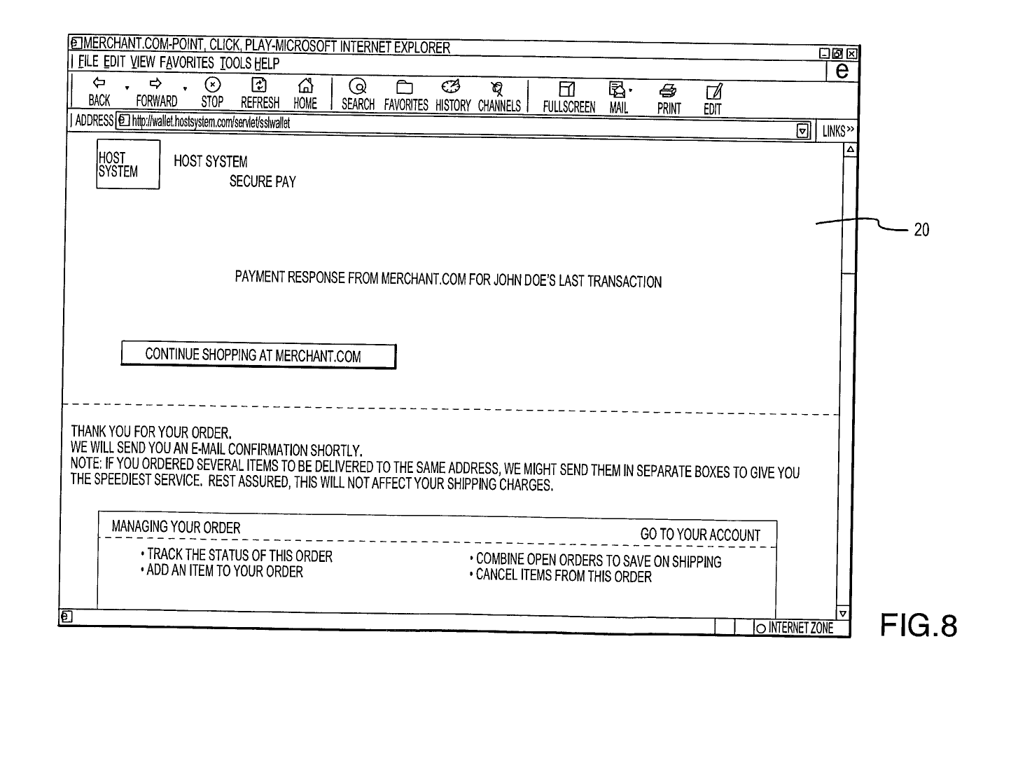

In an exemplary embodiment, the host system 200 then sends and retrieves the HTML pages requested by the merchant website 102 to complete the transaction for the user 1. These web pages and payment fields are the same pages and fields that the user 1 would otherwise have completed manually (STEP 507). As noted above, these fields may be completed automatically using the user-specific information in the user's digital wallet and the newly generated STN in place of the user's primary charge account number. Upon completion of the merchant 100 payment and delivery fields, the user 1 is then presented with the merchant's payment response (e.g., “transaction complete”) via the user's 1 shopping window 15. FIG. 8 depicts a screen shot of an exemplary confirmation page on the user's 1 smart card payment window 20.

FIG. 3 further illustrates the processes of the present invention utilizing user profiled information and the generation of a secondary transaction number in addition to the authentication processes previously described. In this exemplary embodiment, when the user 1 is browsing the merchant's online website 202 the code string on the merchant's server detects the host system 200 smart card reader software on the user system 10 which triggers the appearance of the smart card payments button 220 on the user's shopping browser 11 (STEP 520). The host system server 206a initiates authentication of the user by requesting that the user 1 insert his or her smart card 14 into the smart card reader 12 and enter the proper PIN (STEP 521). Upon authentication, the host system authentication server 206a passes a security cookie to the user system 10 (STEP 522). A digital certificate is then matched to the user's primary transaction account number, which is then transmitted to the wallet server 206b (STEP 523). Data contained in the security cookie is then passed from the user system 10 to the host wallet server 206b (STEP 524). In return, the wallet server 206b presents various options to the user, such as whether to use existing data, update data, add data, etc., in order to complete the transaction with the merchant 100 (STEP 525). User 1 selects the options on the wallet (STEP 526) and the primary transaction account number is transmitted to the secondary transaction number (STN) server 206c, such as the Private Payments™ system utilized by American Express® (STEP 527). The STN server 206c generates a STN and associates this number with the primary transaction account number. The STN may be a single or limited use number that, as mentioned before, may be tailored to a specific merchant, dollar amount, expiration date, etc. The STN and expiration date (and other data if desired) are then returned to the host wallet server 206b (STEP 528). The host wallet server 206b then automatically completes the merchant payment and shipping fields with the appropriate data from a user profile database (e.g., digital wallet), with the STN being transmitted to the merchant instead of the user's primary charge account. If the transaction is successful, the merchant 100 returns the confirmation page to the host (STEP 530) and this confirmation page is then presented to the user 1, thus completing a microchip-enabled online payment and transaction.

Although this invention has been described in language specific to structural features and/or methodological steps, it is to be understood that the invention defined in the appended claims is not necessarily limited to the specific features or steps described. Rather, the specific features and steps are disclosed as exemplary forms of implementing the claimed invention. Accordingly, the scope of the invention should be determined by the appended claims and their legal equivalents, rather than by the examples given above. For example, the steps recited in any of the method or process claims may be executed in any order and are not limited to the order presented in the claims.

We claim:

1. A microchip-enabled online transaction method, comprising the steps of:
authenticating, by a host system, a user whose communication channel with a merchant, is redirected from said merchant to said host system;
obtaining, by said host system, user's transaction account number; and
transmitting transaction information from said host system to said merchant to facilitate a transaction.

2. The method of claim 1, wherein said user communication channel is facilitated with a user system comprising (1) a computer that is configured to access a computerized network, and (2) an authentication instrument reader.

3. The method of claim 2, the authenticating step further comprising the steps of:
issuing a challenge string to said user;
prompting said user to (1) initiate communication between an authentication instrument and said authentication instrument reader, and (2) communicate a user-specific identification signature;
receiving from said user (1) a digital certificate containing information which identifies said authentication instrument, and (2) a signed challenge string which identifies said user; and
verifying that said user is authorized to use said transaction account number associated with said authentication instrument.

4. The method of claim 1, wherein the authentication instrument is any microchip-enabled device.

5. The method of claim 1, wherein the authentication instrument is a smart card.

6. The method of claim 1, wherein the authentication instrument reader is any reader capable of reading a microchip-enabled device.

7. The method of claim 1, wherein the authentication instrument reader is a smart card reader.

8. The method of claim 1, further comprising the step of generating a secondary transaction number and associating said secondary transaction number with said transaction account number, wherein said transaction information provided to said merchant comprises said secondary transaction number instead of said transaction account number.

9. The method of claim 1, further comprising the following steps:
profiling a plurality of merchant websites to determine transaction fields that are required to complete transactions with each of said plurality of merchants; and
storing profiles for said plurality of merchants in a merchant profile database.

10. The method of claim 9, further comprising the following steps:
retrieving from said merchant profile database, said merchant transaction fields required to complete a transaction with said user; and
retrieving from a user profile database, user profile information corresponding to said merchant transaction fields, wherein said transaction information provided to said merchant comprises said retrieved user profile information.

11. The method of claim 10, wherein said merchant transaction fields comprise a transaction number, a transaction number expiration date, and an authorized user name.

12. A computer-implemented online user authentication method, comprising the steps of:
determining, by a merchant, the presence of an authentication instrument reader on a user's computer system;
redirecting said user from a merchant website to a host system website;
issuing, by said host system, a challenge string to said user;
prompting said user to cause an authenticating instrument to communicate with said authenticating instrument reader;
prompting said user to provide a user-specific identification signature;
receiving, from said user, a digital certificate that is associated with a transaction account number and a signed challenge string; and
comparing said digital certificate and said signed challenge with host system data to determine if said user is authorized to use said transaction account number.

13. The method of claim 12, wherein the authentication instrument is a smart card, the authentication instrument reader is a smart card reader, and the user-specific identification signature is a personal identification number or password.

14. A microchip-enabled online transaction method, comprising the steps of:
recognizing the presence of an authentication instrument reader on said user system when said user is browsing a merchant website;
upon recognizing the presence of said authentication instrument reader on the user system, posting a hyperlink button to said user's browser, where upon selection of said hyperlink button by said user, redirecting said user's browser to a host system website; and
receiving user transaction data from said host system to facilitate a transaction with said user.

15. The method of claim 14, further comprising the steps of:
configuring an online shopping website that allows users to browse said website with a web browser and select goods or services for purchase; and
upon user's selection of at least one good or service, presenting said user with a checkout page and prompting said user for payment and delivery information.

16. The method of claim 15, further comprising the step of providing said host system with payment and delivery fields required to complete a transaction with said merchant.

17. A microchip-enabled online transaction method, comprising the steps of:
ascertaining (1) an authentication instrument that is associated with a primary transaction account, and (2) a user-specific identification;
browsing a merchant's website for goods or services;
selecting a product or service to purchase;
clicking on a hyperlink button that redirects a user's browser to a host system website and causing a host system to request user authentication information; and
responding to said host system request by facilitating the communication of said authentication instrument with an authentication instrument reader and providing said user-specific identification signature.

18. The method of claim 17, wherein the authentication instrument is a smart card, the authentication instrument reader is a smart card reader, and the user-specific identification signature is a personal identification number or password.

19. A computerized host system configured to facilitate a microchip-enabled online transaction, comprising:
a web server for maintaining a host system website; and
an authentication server configured to receive a digital certificate and a signed challenge string in order to determine if said user is authorized to use a particular transaction account number.

20. The computerized host system of claim 19, further comprising:
a secondary transaction server that is configured to (1) generate a secondary transaction number, and (2) associate said secondary transaction number with a user's transaction account number.

21. The computerized host system of claim 19, further comprising:
a wallet server that maintains data relating to said user, wherein said wallet server is configured to interact with said authentication server and said secondary transaction server in order to provide data to complete merchant payment and delivery fields as appropriate to facilitate a transaction for said user.

22. A microchip-enabled online transaction method, comprising the steps of:
profiling a plurality of merchant websites to determine the appropriate transaction fields for completing transactions with each of said plurality of merchant websites;
storing in a host system profile database said profile for each of said plurality of merchant websites;
communicating with a user system over the internet, wherein upon establishing said communication with said user system, it is determined that a user desires to complete a transaction with a particular merchant;
recognizing the presence of a smart card reader on said user system;
prompting said user to cause user's smart card to communicate with said smart card reader;
issuing to said user a challenge string;
prompting said user to enter a user-specific passcode;
receiving a smart card-specific digital certificate;
receiving a signed challenge string;
comparing said smart card-specific digital certificate and said signed challenge string to facilitate two-factor authentication to verify that said user is authorized to use a transaction account number;
generating a secondary transaction number and associating said secondary transaction number with said transaction account number; and
providing said secondary transaction number to a merchant to facilitate the completion of a transaction between said user and said merchant.

23. A microchip-enabled online transaction method, comprising the steps of:
authenticating a user whose web browser was redirected from a merchant website to a host system website;
retrieving from a host system database a transaction account number associated with said user;
generating a secondary transaction number and associating said secondary transaction number with said transaction account number; and
transmitting information comprising the secondary transaction number to said merchant in order to facilitate a transaction.

24. A microchip-enabled online transaction system and method, comprising the steps of:
configuring a merchant website to send an applet to a user system to determine if said user system is configured with a host system authentication instrument reader and software;
posting to a user's web browser a hyperlink button capable of redirecting a user from said merchant website to a host system website in order to facilitate user authentication;
receiving from said host system transaction data associated with said user; and
completing said transaction with said user.
